(19) United States
(12) Patent Application Publication
(10) Pub. No.: US 2014/0233398 A1
(43) Pub. Date: Aug. 21, 2014

(54) MULTI-HOP ROUTING PROTOCOL

(71) Applicant: ORANGE, Paris (FR)

(72) Inventors: Apostolos Kountouris, Grenoble (FR); Ochikhand Erdene-Ochir, Grenoble (FR); Marine Minier, Lyon (FR); Fabrice Valois, Lyon (FR)

(21) Appl. No.: 14/348,586

(22) PCT Filed: Sep. 25, 2012
(86) PCT No.: PCT/FR2012/052143

§ 371 Date: Mar. 28, 2014

(30) Foreign Application Priority Data
Sep. 30, 2011 (FR) 1158828

(51) Int. Cl. H04L 12/751

(52) U.S. Cl. CPC H04L 45/02
USPC 370/242; 370/254

(57) ABSTRACT

Disclosed is a method for calculating a route for a transfer of data between a source node and a destination node via at least one intermediate node in a network comprising a plurality of nodes, which, for a current node of said route, comprises a set of nodes adjacent to said current node. The method is suitable for selecting a selection law from a set of selection laws and for choosing an intermediate node according to the current node, by applying the selected law to all or a portion of the nodes of the predetermined set for the current node. Also disclosed is a node-forming device which implements the route calculation method.

The invention pertains to the field of infrastructure-less communication networks and more particularly to the multi-hop routing protocols used in these networks.

In a known manner, an infrastructure-less network, also called an adhoc network, is a network comprising nodes, for example sensors, connected gradually, without central control.

In a multi-hop routing protocol, a source node which may not reach a destination node directly, because for example of distance or resource constraints, uses intermediate nodes to relay the message. Thus, the source node dispatches the message to one of its neighbors, which in its turn relays the message to one of its neighbors, and so on and so forth until the final destination is reached. The nodes interact only with their direct neighbors and take localized routing decisions. They do not know the global topology of the network.

This protocol operates in two steps. During a first step, the routes are calculated. Next, in a second step, the data packets are conveyed via the calculated routes. The routes are periodically recalculated to take account of possible changes of topology of the network.

The Greedy Forwarding routing protocol, described for example in a document by Stojmenovic, Ivan, entitled “Position based routing in ad hoc networks” published in “IEEE Communications magazine”, is an example of a multi-hop routing protocol. In this routing protocol, the routes are calculated by incremental construction. A metric calculated by a node on the basis of the information provided by the neighbor nodes, makes it possible to select the following node.

More precisely, the Greedy Forwarding routing protocol uses two types of information packets: HELLO and DATA. The HELLO packets are signaling messages. The DATA packets make it possible to transmit the data. Each node of the network knows its own geographical position and that of the final destination. Each node exchanges its location information with its direct neighbors by dispatching HELLO packets periodically. Thus, each node knows the location of its neighbors. A node, having data to be transmitted, uses the location information received from its neighbors to select the neighbor node closest to the final destination and transmits the data in one or more DATA packets to the selected node.

This protocol is very efficient in particular in terms of deadlines, delivery rate and consumption.

However, it is very sensitive to the falsification of the information used to calculate the metric. For example, the HELLO packets transmitted by a malicious node contain an erroneous item of location information, for example close to the final destination. On the basis of this item of information, this malicious node is therefore systematically chosen from among the neighbor nodes of a node seeking to determine a following node. Said node then systematically transmits to this malicious node, the DATA packets that it has to transmit but the malicious node does not retransmit the DATA packets to the following node. Thus, a single malicious neighbor that attracts all of the traffic of a node suffices to obtain total disconnection between a source node and the destination node.

A need therefore exists for a simple routing protocol that is robust to attempts to disturb the operation of the network by hacking practices.

The invention improves the situation.

For this purpose, the invention pertains to a method for calculating a route for a transfer of data between a source node and a destination node in a network comprising a plurality of nodes, the method comprising, for a current node of said route, a step of determining from among the plurality of nodes a set of neighbor nodes of said current node,

characterized in that it furthermore comprises:
a step of selecting a selection law from among a set of selection laws;
a step of choosing a node following said current node in said route by applying the selected law to all or some of the nodes of the set determined for said current node.

During the calculation of a route between a source node and a recipient node, a current node of the route selects the following node from among the neighbor nodes. This selected following node is either the recipient node if it is accessible directly by the current node, or an intermediate node chosen from the set of neighbor nodes of the current node.

This following node is selected by applying a selection law chosen from among several laws. The choice of the following node varies as a function of the law selected. Thus, it is difficult for a fraudster to foresee the node chosen by a current node, and consequently the route followed by the data. The behavior of the routing system is not foreseeable. Thus, the routing protocol is robust to hacking.

According to one embodiment of the method for calculating a route, the selection law is selected in a random manner.

The random choosing of a selection law from among a set of laws prevents foresight of which law will be selected and therefore prevents advance knowledge of the nodes of the route. The system is thus more resistant to hacking.

According to another embodiment of the method for calculating a route, used alone or as a supplement to the previous embodiment, the set of laws comprises at least one random selection law and at least one deterministic selection law.

A random selection law makes it possible to obtain a different result upon each selection of a following node and thus to vary the routes over which the messages travel. Thus with the use of a random selection law, it is not possible to determine in advance the route followed by a data message.

A deterministic selection law is a law making it possible to select a node from among a set of nodes according to a predetermined criterion. Such a selection law is, for example, a law choosing from among the neighborhood of a node, the node geographically closest to the destination. With such a law, the nodes always progress toward the destination in the same manner.

The alternation of random selection laws and of deterministic laws makes it possible globally for the messages received by a node to be caused to progress by the latter toward the destination node while rendering the process for selecting the following node unforeseeable.

According to another embodiment of the method for calculating a route, the selection law is selected as a function of at least one value representative of the probability of presence of a malicious node in said set.

A value, calculated by a node as a function of its neighbors, representative of the probability of presence of a malicious node in the set of neighbors of a current node, makes it possible to prejudge the potential presence of malicious nodes among the neighbors. The calculated value is thereafter compared with a threshold and the choice of the selection law is made as a function of the result of this comparison. For example, if this value is greater than a predetermined threshold, the selection law selected is for example a random selection law, for example a uniform selection law. On the other hand, if this value is less than said threshold, a deterministic selection law can be chosen, for example a selection law choosing the neighbor node closest to the destination, thus allowing maximum progression of the messages toward their destination.

According to a particular embodiment, the method for calculating a route furthermore comprises:
a step of determining a first and a second subset of nodes, said first subset consisting of nodes of said set and the second subset consisting of nodes of said first subset,
a step of verifying a first confidence criterion relating to said first subset;
   and the selected law is applied to said first subset or to said second subset as a function of the result of the verification of the first confidence criterion.

The first confidence criterion makes it possible to determine whether a malicious node is potentially present among a first subset of neighbor nodes. If the probability of presence of a malicious node among the nodes of the first subset is greater than a predetermined threshold, the selected law is applied to the nodes of the first subset, otherwise, it is applied to the nodes of the second subset. The first subset contains the second subset. If the probability of presence of a malicious node among the nodes of the first subset is greater than a predetermined threshold, the selected law is applied to a larger number of nodes. Thus, the probability of choosing a malicious node is lower. The application of the selected law to the second subset makes it possible to increase the speed of transfer of the messages.

According to a particular characteristic of this embodiment, the determination of the first and/or of the second subset comprises a step of selecting at least one node as a function of a criterion of distance between the node and the destination node.

The distance between two nodes is a metric which is simple to calculate. The use of the distance makes it possible to determine nodes closer to the destination.

The first subset of nodes consists for example of the neighbor nodes closer to the destination than the current node. The second subset consists for example of half the nodes closest to the destination.

When the first confidence criterion is satisfied, that is to say that at the node is considered to be malicious, a node following a current node is selected from among the nodes of the second subset, that is to say from among the nodes closest to the destination node.

According to another characteristic, the first confidence criterion is satisfied if the absolute value of the difference between on the one hand a median distance between the nodes of said first subset and the destination node and on the other hand a mean distance between said nodes of said first subset and the destination node is less than a predetermined threshold value.

When the difference between a calculated median distance and a calculated mean distance between the nodes of a set and a destination node is less than a predetermined threshold value, this signifies that the distribution of the nodes is not symmetric. This known principle is applied here to detect the presence of a malicious node.

A malicious node will indicate an erroneous geographical position, for example a position closer to the destination node so as to be selected by the current node. The comparison of the median distance and of the mean distance makes it possible to determine whether a set of nodes may or may not be considered to be reliable.

If the absolute value of the difference between the median distance between the nodes of said first subset and the destination node, that is to say the distance between the barycenter of the nodes of the first subset and the destination node, and the mean distance between said nodes of said first subset and the destination node is less than a predetermined threshold value, the first subset of nodes is considered to be reliable and the following intermediate node is selected from among the second subset of nodes.

In the converse case, a suspicion of fraud weighs on the neighbor nodes of the first subset and the following node is selected from among the first subset. The selection of a node from among the first subset, larger than the second subset, increases the unforeseeability of the choice.

According to a particular mode of embodiment, used alone or in combination with another mode, the method for calculating a route furthermore comprises:
a step of determining a first and a second subset of nodes, said first subset consisting of nodes of said set and the second subset consisting of nodes of said first subset,
a step of verifying a second confidence criterion relating to a said subset;
   and the law is selected as a function of the result of the verification of a second confidence criterion.

A second confidence criterion is used to determine whether a malicious node is present among a subset of nodes. As a function of the result, the selected law applied is different, for example a selection law allowing faster message progression or on the contrary a more random selection law.

The second confidence criterion makes it possible to determine whether the set of nodes considered should be considered to be resilient or non-resilient. If the probability that a malicious node is less than a predetermined threshold, a selection law making it possible to progress the messages more quickly toward the destination can be applied. On the contrary, if the probability that a malicious node is greater than this threshold, a random law is applied. When applying a random law, the malicious node has a reduced chance of being chosen.

According to a particular characteristic of this embodiment, the selected law is weighted by at least one weighting coefficient if the second confidence criterion is satisfied and the selected law is equiprobable if said second criterion is not satisfied.

As a function of the verification of the second criterion, the selected law is an equiprobable or non-equiprobable law. The application of weighting coefficients makes it possible to increase the probability of certain nodes and/or to decrease the probability of other nodes, and thus to favor the selection of certain nodes, for example the nodes closest to the destination node.

According to another characteristic, the second criterion is satisfied if the absolute value of the difference between on the one hand a median distance between the nodes of said first subset and the destination node and on the other hand a mean distance between said nodes of said first subset and the destination node is less than a predetermined threshold value.

The calculation of the difference between a median distance between the nodes of said first subset and the destination node and a mean distance between said nodes of said first subset and the destination node is a simple criterion for determining a probability of presence of a malicious node among the nodes of the first subset.

The invention also pertains to a device forming a node of a network comprising a plurality of nodes, said node comprising means for determining a set of neighbor nodes of said node from among the plurality of nodes. The device comprises:
means for selecting a selection law from among a set of selection laws;
means for choosing a node following said node in a route by applying the selected law to all or some of the nodes of the set determined for said node.

The invention also pertains to a sensor able to collect data and to retransmit them to a collection device, characterized in that it comprises a device forming a node such as described previously.

The invention further pertains to a system comprising a plurality of devices forming nodes, comprising at least one device forming a node such as described previously.

The invention relates finally to a computer program product comprising instructions for implementing the steps of a method for calculating a route, such as described previously, when it is loaded and executed by a processor.

Other particular features and advantages of the present invention will be apparent in the following description of embodiments given by way of nonlimiting examples, with reference to the appended drawings, in which:

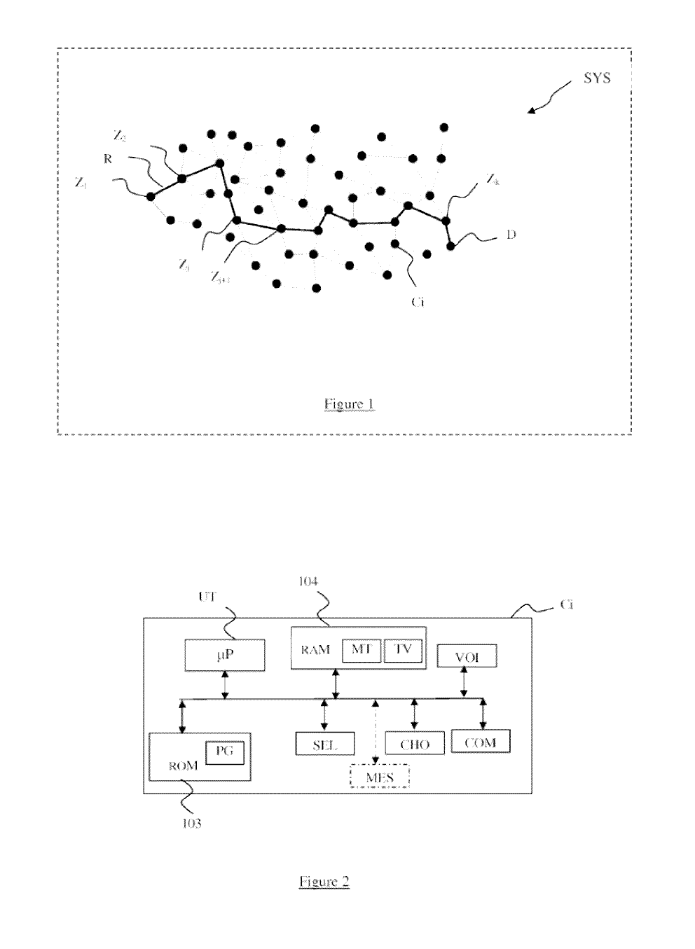

FIG. 1 is a general diagram illustrating the general context of the invention,

FIG. 2 is a block diagram representing a sensor able to carry out the steps of a route calculation method according to one embodiment of the invention,

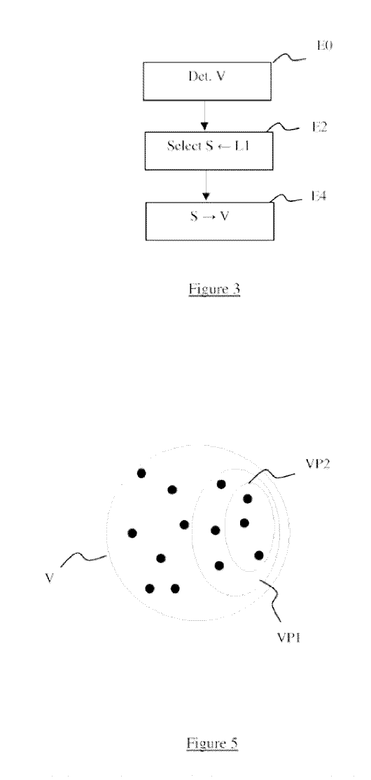

FIG. 3 is a flowchart illustrating the various steps of a route calculation method according to a first embodiment,

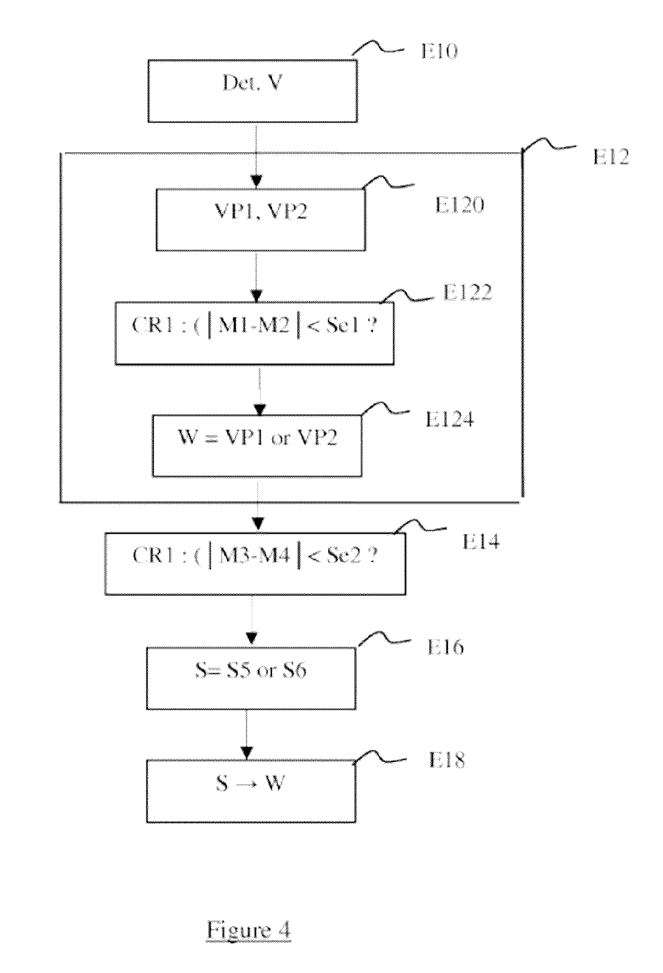

FIG. 4 is a flowchart illustrating the various steps of a route calculation method according to a second embodiment,

FIG. 5 is a diagram illustrating subsets of sensors determined according to one embodiment.

The invention is implemented by means of software and/or hardware components. In this regard, the term “module” can correspond in this document equally well to a software component, to a hardware component or to a set of hardware and/or software components, able to implement a function or a set of functions, according to what is described hereinbelow for the module concerned.

A software component corresponds to one or more computer programs, one or more subroutines of a program, or in a more general manner to any element of a program or of a piece of software. Such a software component is stored in memory and then loaded and executed by a data processor of a physical entity (terminal, server, gateway, set-top-box, router, etc) and is able to access the hardware resources of this physical entity (memories, recording media, communication bus, electronic input/output cards, user interfaces, etc).

In the same manner, a hardware component corresponds to any element of a hardware set. It may involve a programmable hardware component or one with integrated processor for software execution, for example an integrated circuit, a chip card, an electronic card for the execution of a firmware, etc.

A first embodiment of the invention will now be described with reference to FIGS. 1 to 3.

FIG. 1 represents a system SYS comprising a plurality of sensors C1, C2, . . . Ci . . . placed randomly according to a uniform distribution in a geographical area.

Each sensor Ci is for example a measurements sensor which is able to periodically perform a set of measurements and to transmit a data message containing the measurements performed, to a collection device D.

Each sensor Ci is also able to receive a data message originating from another sensor of the system SYS and to retransmit it to the collection device D.

Each sensor Ci respectively represents a node, as does the collection device D.

The plurality of nodes is organized into a so-called infrastructure-less network or adhoc network.

In the subsequent description, the collection device D is also called destination node D and a sensor is also called node.

A sensor represents a node-forming device.

Each node is able to communicate with the neighbor nodes of this node via a wireless link, for example a Zigbee or wife link, or another link of radio type.

A neighbor node of a current node is a node within communication range of this current node. More precisely, the euclidian distance between a current node and a neighbor node of this current node is less than the communication range. It is specified that the communication range may vary according to the propagation conditions.

The link between two nodes is a bidirectional link.

In a known manner, limitation of the transmission power for wireless links does not allow a current node to dialog directly with all of the nodes of the system SYS.

Hence, the transmission of a data message from a current node to a node out of range of this current node is performed via one or more intermediate nodes. More generally, the transmission of a data message from a source node to the collection device D is performed according to a multi-hop routing protocol.

Subsequent, for example, to the inputting of a set of measurements, a sensor of the set SYS, for example a sensor Z1, desires to transmit a data message MD comprising the measurements performed, to the collection device D. The collection device D not being within communication range of the sensor Z1, the sensor Z1 may not transmit the data message directly to the collection device D.

Transfer of the data message between the sensor Z1 and the collection device D requires the calculation of a route R between the sensor Z1 and the collection device D via at least one intermediate node or sensor. The data message MD is transmitted gradually via sensors of the system SYS until it reaches the collection device D.

The route is constructed in an incremental manner More precisely, the sensor Z1 selects, from among its neighbors, a sensor, here called first intermediate sensor, to which it dispatches the data message MD. The first intermediate sensor thereafter selects, from among its neighbors, a second intermediate sensor and so on and so forth until an intermediate sensor, within range of the collection device D, is selected.

The calculation of a route, traveled by the data message MD between a source node, here the sensor Z1, and a destination node, here the collection device D, thus comprises the selecting of k intermediate nodes or sensors Z2, . . . Zk+1.

In the embodiment described here, the selecting of each intermediate node is performed according to a route calculation method comprising steps E0 to E4, described with reference to FIG. 3. The route calculation method is implemented respectively by the source node Z1 and the first (k−1) intermediate sensors selected Z2, Z3 . . . Zk. The last intermediate sensor Zk of the route R transmits the data message MD directly to the destination node D.

By way of alternative, steps E0 to E4 are implemented for just some of the nodes of a group comprising the source node and the first (k−1) intermediate nodes. The selection of the other intermediate nodes is then performed according to a known method of the state of the art.

By way of alternative, the plurality of nodes comprises several source nodes and/or several destination nodes.

A source node when transmitting one message can be considered to be a destination node when transmitting another message.

FIG. 2 represents an exemplary sensor Ci of the system SYS.

The sensor Ci comprises in a known manner, in particular a processing unit UT equipped with a microprocessor, a read-only memory of ROM or EEPROM type 103, a random-access memory of RAM type 104, an interface for communication COM with neighbor nodes and/or the destination node D by a wireless link.

The read-only memory 103 comprises registers storing a computer program PG.

The processing unit UT is driven by the computing program PG so as to implement in particular the route calculation method according to an embodiment of the invention, described subsequently with reference to FIG. 3.

The sensor Ci also comprises a module for determining the neighbors VOI, a selection module SEL, a module for choosing an intermediate node CHO as well as a temporary memory MT, for example a memory of RAM type, able to record a data message, for example a measurements report, received from a neighbor node.

The sensor Ci can also comprise a measurements module MES able to periodically perform a set of measurements and to record the result of these measurements in the temporary memory MT.

The communication module COM is able to receive a data message and to store the data received in the temporary memory MT.

The method of the invention implemented by a sensor Zj of the system SYS will now be described with reference to FIG. 3.

The sensor Zj is either the source node Z1, or an intermediate sensor Z2, Z3 . . . or Zk−1. The sensor Zj here represents a current node.

Subsequent, for example to the reception of a data message, the sensor Zj implements steps E0 to E4 such as described with reference to FIG. 3.

A data message received by the sensor Zj comprises, in this embodiment, in particular an identifier of DATA type, an identifier of the destination node D, the geographical coordinates of the destination node D, an identifier of the source node Z1 and the geographical coordinates of the source node Z1.

In the embodiment described here, a set L1 of selection laws comprises for example 4 selection laws S1, S2, S3 and S4.

The first selection law S1 is for example a uniform probability law. In a known manner, a uniform law is a random law according to which the probability p(s) in a set S of nodes is identical for all the nodes s of the set S.

The second selection law S2 is for example a maximum entropy law based on the mean distance between the nodes of a set of nodes and the destination node.

The third selection law S3 is for example a maximum entropy law based on the median distance between the nodes of a set of nodes and the destination node.

The fourth selection law S4 is for example a maximum entropy law based on the distance between the current node considered and the destination node.

A maximum entropy law is a discrete probability law which makes it possible to select an element x from among the elements x1, x2, . . . xn of a set X and is described for example in the document “Random Walks on sensors networks, In Proceedings of the 5th International Symposium On Modeling and Optimization in Mobile, Ad hoc and Wireless Networks—April 2007” by L. Lima and J. Barros.

A maximum entropy law based on a value α, denoted P(α), is such that:
the sum of the probabilities p(x) of each element x of S is equal to 1. Stated otherwise:

p(x1)+p(x2)+ . . . +p(xn)=1,
the sum, for each element x of X, of the values (p(x)*d(x)) is equal to α with d(x) representing the distance of the element x from a determined point. Stated otherwise:

p(x1)*d(x1)+p(x2)*d(x2)+ . . . +p(xn)*d(xn)=α
the sum, for each element x of X, of the values (p(x)*ln(1/p(x)) is a maximum with ln representing the Naperian Logarithm function. Stated otherwise:

p(x1)*ln(1/p(x1)+p(x2)*ln(1/p(x2)+ . . . +p(xn)*ln(1/p(xn) is a maximum.

The maximization of the sum (p(x)*ln(1/p(x)) is for example performed by a known Lagrange multiplier procedure. The solving of the linear equations are for example solved with the aid of simple numerical calculation procedures such as Newton's procedure or the gradient descent procedure and the arithmetic calculations are for example performed by executing a CORDIC (for “COordinate Rotation DIgital Computer”) algorithm.

The median distance between a set of nodes and the destination node is here the distance between the barycenter of the position of the nodes of the set and the destination node.

The mean distance between a set of nodes and the destination node is the mean distance calculated over the set of distances of each node of the set from the destination node.

By way of alternative, the number of laws of the set L1 is different from 4 and/or the set of laws L1 comprises one or more laws different from the laws S1, S2, S3 and S4.

During a first step E0, the current sensor Zj selection module VOI determines from among the plurality of nodes of the system SYS, a set V of neighbor nodes Vj of the current node Zj.

More precisely, each node of the system SYS periodically broadcasts, for example every 3 seconds, in broadcast mode, a HELLO message.

A HELLO message transmitted by a node comprises, in this embodiment, in particular an identifier of HELLO type, an identifier of this node and the geographical coordinates of this node.

The current node Zj thus receives HELLO messages originating from its neighbors.

The current node Zj maintains a neighborhood table TV (FIG. 2) in which it stores the information relating to each neighbor. The neighborhood table TV is for example an area of the RAM memory 103.

Upon each reception of a HELLO packet, the current node Zj updates its neighborhood table TV.

The stored information expires after 2 and a half seconds. Thus a node which is no longer communicating, no longer appears in its neighbors' neighborhood table.

Step E0 is followed by a step E2, during which the sensor Zj selection module SEL selects a selection law S from the set of laws L1.

In the embodiment described, the selection law S is selected in a random manner.

By way of alternative, the laws are selected according to a predefined sequence.

Next, during a step E4, the module for choosing an intermediate node CHO of the sensor Zj chooses an intermediate node Zⱼ₊₁ following the current node Zj by applying the selected law S to the set V of neighbors Vj.

By way of alternative, the route calculation method implemented by the sensor Zj comprises a step E3 of determining a subset of nodes from among the neighbor nodes, for example the subset of the neighbor nodes that are closer to the collection device D than the current node Zj and during step E4, the selection law S selected during step E2 is applied to the subset determined.

A second embodiment of the route calculation method in the system SYS will now be described with reference to FIGS. 4 and 5.

The route calculation method here comprises steps E10 to E18 implemented by at least one sensor of a group comprising the source sensor Z1 and at least one intermediate node or sensor.

In this embodiment, a set of laws L2 comprises for example 2 selection laws S5 and S6.

The first law S5 is for example an equiprobable law.

The second law S6 is a probability law in which the probabilities are weighted as a function of weighting coefficients. For example, a weighting coefficient P applied for a node is dependent on the distance between this node and the destination node D. This weighting allows the messages to attain the destination node D more rapidly.

The selection law S6 is for example the law S5 in which the probabilities are weighted as a function of the weighting value P.

By way of alternative, the probabilities of selection of the selection law S6 are determined by applying for example the principle of maximum entropy so as to obtain with the weighting a mean distance equal to the median distance without weighting.

With reference to FIG. 4, during a first step E10, similar to step E0, the sensor Zj determination module VOI determines, from among the plurality of the sensor nodes of the system SYS, a set V of neighbor nodes Vj of the current node Zj.

During a step E12, the determination module VOI determines a set W of nodes to which a law of selection of the set of laws L2 will be applied.

More precisely, step E12 here comprises substeps E120, E122 and E124.

During a first substep E120, the sensor Zj determination module VOI determines a first subset VP1 and a second subset VP2 of nodes.

The first subset VP1 is a subset of the set V of the neighbor nodes of the current node Zj.

The first subset VP1 is for example the set of the neighbor nodes of the sensor Zj that are closer to the collection device D than the current node Zj. For example, a node of the first subset VP1 is a node such that the distance between this node and the destination node D is less than the distance between the current node Zj and the destination node D.

By way of alternative, the first subset VP1 is the set V of neighbor nodes.

The second subset VP2 is a subset of the first subset VP1. The second subset VP2 consists, for example, of half the nodes of the first subset VP1, the half closest to the destination node D.

FIG. 5 illustrates an example of first subset VP1 and of a second subset VP2 which are determined by a current node Zj.

The first and the second subsets are determined as a function of a metric. The metric used here is the distance between a node and the destination node D.

The distance between a neighbor node and the destination node D is calculated by the sensor Zj by using on the one hand the geographical position, contained in the data message received, of the destination node D and on the other hand this neighbor node's geographical position contained in the neighborhood table TV.

By way of alternative, the metric used is a number of hops linking a node to the destination node D. A number of hops is for example obtained by broadcasting a message emitted by the destination node D containing a number equal to zero of hops and propagated gradually by the nodes after incrementation of the number of hops.

Next, during a substep E122, the sensor Zj determination module VOI verifies a first confidence criterion CR1.

The verification of the first confidence criterion CR1 comprises the calculation of a first M1 and of a second metric M2 that are representative of the first subset VP1 and then the comparison of the calculated metrics.

The first metric M1 is for example the median distance between the nodes of the first subset VP1 and the destination node D, that is to say the distance between the barycenter of the nodes of the first subset VP1 and the destination node D. The second metric M2 calculated is the mean distance between the nodes of the first subset VP1 and the destination node D.

The comparison of the median distance and of the mean distance is a criterion making it possible to detect potential fraud. Indeed, a fraudulent node wishing to attract the traffic transmits a false geographical position in the HELLO packets destined for its neighbors. For example, it indicates a geographical position closer to the destination node D than its real position. This erroneous geographical position influences differently the mean distance more than the median distance, calculated over the nodes. Thus, a difference between the median distance and the mean distance greater than a first predetermined threshold Se1 indicates a possibility of presence of a fraudulent node.

Substep E122 is followed by a substep 124 during which the sensor Zj determination module VOI chooses a set W of nodes to which a selection law S of the set L2 will be applied.

If the first confidence criterion CR1 is satisfied, that is to say if the calculated difference, in absolute value, between the median distance M1 and the mean distance M2 is less than a predetermined threshold Se1 (|M1−M2|<Se1), the set W chosen is the second subset VP2.

If the first confidence criterion CR1 is not satisfied, the set W chosen is the first subset VP1.

Step E12 is followed by a step E14 of verifying a second confidence criterion CR2.

The verification of the second confidence criterion CR2 comprises the calculation of a third M3 and of a fourth metric that are representative of the set of nodes W which is chosen during step E12 and then the comparison of the calculated metrics.

The third metric M3 is for example the median distance, that is to say the distance between the barycenter of the nodes of the set W and the destination node D. The fourth metric M4 calculated is the mean distance between the nodes of the set W and the destination node D.

During a following step E16, the sensor Zj selection module SEL selects from the set of laws L2 a selection law S as a function of the verification of the second confidence criterion CR2.

For example, the selection law S6 is selected if the absolute value of the difference between the median distance M3 and the mean distance M4 is less than a second predetermined threshold Se2 (|M3−M4|<Se2), and the selection law S5 is selected otherwise.

Next, during a step E18, the current node Ci chooses the following intermediate node Zⱼ₊₁ by applying the law S selected during step E16 to the set of nodes W determined during step E12.

By way of alternative, the method does not comprise step E12, and during step E18, the law S selected during step E16 is applied to the set V of neighbors.

1. A method for calculating a route for a transfer of data between a source node and a destination node D in a network comprising a plurality of nodes, the method comprising, for a current node of said route, a step of determining from among the plurality of nodes a set of neighbor nodes of said current node,
wherein the method further comprises:
selecting a selection law from among a set of selection laws; and
choosing a node following said current node in said route by applying the selected law to all or some of the nodes of the set determined for said current node.

2. The method for calculating a route as claimed in claim 1, wherein the selection law is selected in a random manner.

3. The method for calculating a route as claimed in claim 1, wherein the set of laws comprises at least one random selection law and at least one deterministic selection law.

4. The method for calculating a route as claimed in claim 1, wherein the selection law is selected as a function of at least one value representative of the probability of presence of a malicious node in said set.

5. The method for calculating a route as claimed in claim 1, wherein the method further comprises:
determining a first and a second subset of nodes, said first subset consisting of nodes of said set and the second subset consisting of nodes of said first subset,
verifying a first confidence criterion relating to said first subset;
wherein the selected law is applied to said first subset or to said second subset as a function of the result of the verification of the first confidence criterion.

6. The method for calculating a route as claimed in claim 5, wherein the first confidence criterion is satisfied if the absolute value of the difference between on the one hand a median distance between the nodes of said first subset and the destination node and on the other hand a mean distance between said nodes of said first subset and the destination node is greater than a predetermined threshold value.

7. The method for calculating a route as claimed in claim 1, wherein the method further comprises:
determining a first and a second subset of nodes, said first subset consisting of nodes of said set and the second subset consisting of nodes of said first subset,
verifying a second confidence criterion relating to a said subset;
wherein the law is selected as a function of the result of the verification of a second confidence criterion.

8. The method for calculating a route as claimed in claim 7, wherein the selected law is weighted by at least one weighting coefficient if the second confidence criterion is satisfied and the selected law is equiprobable if said second criterion is not satisfied.

9. A device forming a node of a network comprising a plurality of nodes, comprising a component configured to determine a set of neighbor nodes of said node from among the plurality of nodes, wherein the device comprises:
a component configured to select a selection law from among a set of selection laws;
a component configured to choose a node following said node in a route by applying the selected law to all or some of the nodes of the set determined for said node.

10. A sensor able to collect data and to retransmit them to a collection device wherein the sensor comprises a device as claimed in claim 9.
